(19) United States
(12) Patent Application Publication
(10) Pub. No.: US 2013/0275194 A1
(43) Pub. Date: Oct. 17, 2013

(54) ELECTRONIC TRANSACTION METHOD AND SYSTEM

(71) Applicant: Ariya Priyasantha, Lancashire (GB)

(72) Inventor: Ariya Priyasantha, Lancashire (GB)

(73) Assignee: 2ERGO LIMITED, Salford, Lancashire (GB)

(21) Appl. No.: 13/877,502

(22) PCT Filed: Oct. 4, 2011
(86) PCT No.: PCT/GB2011/051888

§ 371 Date: Jun. 13, 2013

(30) Foreign Application Priority Data
Oct. 4, 2010 (GB) 1016674.2
Jun. 15, 2011 (GB) 1110089.8

(51) Int. Cl. G06Q 30/02

(52) U.S. Cl. CPC G06Q 30/0222
USPC 705/14.23

(57) ABSTRACT

Consumer with a token incorporating a transaction code on their Smartphone brings their Smartphone to a retailer equipped with a transaction module. When purchasing an article, connection is established between the Smartphone and the transaction module and the transaction module transmits its identity code to the Smartphone. The Smartphone subsequently runs the transaction code and identity code through an authentication algorithm. If authenticated, the Smartphone sends authentication signal to the transaction module and a transaction report to a transaction server. Upon receipt of the authentication signal, the transaction module outputs a corresponding validity indication. This enables any retailer possessing a transaction module to process an electronic transaction without directly altering the retailers system. This therefore provides a simpler and potentially cheaper way of implementing electronic transactions at a wide variety of unrelated retail outlets.

The present invention relates to an electronic transaction method and system and in particular to a method and system for implementing electronic voucher redemption or electronic payments or purchases.

Conventionally, when a consumer presents a discount voucher to a retailer in connection with an associated article, the retailer discounts the price of the article by a predetermined amount. The cost of the discount is usually ultimately borne by the supplier of the article. As such, once the discount is applied the retailer and the supplier must ultimately reconcile use of vouchers with supply of discounted articles.

In the past, most vouchers have been printed on paper/card and may contain instructions to the retailer and/or consumer. In some cases, the voucher may contain a bar code readable by an electronic point of sale device (EPOS). The paper vouchers also provide an audit trail for use in reconciling voucher use. Increasingly, vouchers are now being issued in electronic form to consumers, for instance via email or text message. With the ever increasing availability of Smartphones and other such portable consumer devices, consumers wish to be able to directly present such an electronic voucher to a retailer.

The key feature of these electronic vouchers is a code which identifies and authenticates the vouchers validity. In most voucher schemes the code provided to each consumer is unique and may only be used once. The use of unique codes enables auditing of a voucher use. To prevent fraud or multiple uses of a voucher the code must be authenticated as valid, by transmitting or entering it into an EPOS. The EPOS can then authenticate the code either via a direct reference to a voucher server, via a local algorithm or by taking the consumer on trust. Ultimately, for reconciliation of voucher use and/or for cancelling used vouchers, the code must be transmitted to the voucher server.

In order to apply such an electronic voucher scheme efficiently and reduce the chance of fraudulent use, it is therefore necessary for the retailer's EPOS to be able to communicate with the voucher server in a timely fashion. To achieve this, requires a considerable level of integration between the voucher scheme and the retailer's own sale records system and/or EPOS. Implementing such a level of integration can be difficult, costly and time consuming to achieve. As such, whilst electronic voucher schemes may be implemented, they may be limited to particular retailers on grounds of the cost of implementing the voucher scheme with multiple different sale records systems. Additionally, the voucher scheme may not be implemented at all with independent retailers who do not have an existing sale record system with provision for transmitting sale records to a remote server. This limitation can cause consumer frustration. Additionally, limiting the range of participating retail outlets may significantly reduce the effectiveness of such schemes.

A further difficulty with electronic voucher schemes is that a user may not remember that they have an applicable electronic voucher. This is a particular problem where there is a significant interval between the receipt of the voucher and a user being in a position to redeem said voucher.

Similarly, in the case of making a payment for an article using an electronic system, this is typically achieved by having a device or item embodying some form of electronic credit recognised by a retailer's own sale records system and/or EPOS. Whilst a number of such systems exist, they typically can only operate effectively if there is a considerable level of integration between the payment scheme and the retailer's own sale records system and/or EPOS. Implementing such a level of integration can be difficult, costly and time consuming to achieve. As such, whilst electronic payment schemes may be implemented, they may be limited to particular retailers on grounds of the cost of implementing the voucher scheme with multiple different sale records systems or the cost imposed on the retailer by the operator of the system.

It is therefore an object of the present invention to provide a new electronic transaction method and system that overcomes or alleviates such problems.

According to a first aspect of the present invention there is provided a method suitable for making electronic transactions using an electronic token stored on a portable consumer device, the method comprising the steps of: transmitting a module identification code from a transaction module to said consumer device; carrying out on the consumer device an authentication routine using the identification code and a transaction code contained in the electronic token; transmitting an authentication signal indicative of the outcome of the authentication routine from said consumer device to said transaction module; and outputting a suitable validity indication from said transaction module in response thereto.

According to a second aspect of the present invention there is provided an electronic transaction module suitable for making electronic transactions using an electronic token stored on a portable consumer device, the transaction module comprising: memory means for storing a module identity code; communication means for transmitting said module identity code to a portable consumer device, and receiving an authentication signal therefrom; and output means for outputting a suitable validity indication in response to said authentication signal.

According to a third aspect of the present invention, there is provided a system for implementing the method of the first aspect of the present invention, the system comprising: one or more transaction modules according to the second aspect of the present invention; and a transaction server.

The above method, module and system thus provides for verification of electronic transactions using a simple transaction module independent of retailer's sale records systems. As such, this method may be used to implement an electronic transaction scheme, such as a voucher redemption scheme, cheaply, rapidly and easily with a wide range of retailers.

The transaction may be a purchase, voucher redemption or similar. In the case of a purchase, the token may be an electronic receipt. The electronic receipt may contain data identifying the value of the transaction and/or the identity of the articles for purchase. In the case of voucher redemption, the token may be an electronic voucher. The voucher may contain data identifying the value of the transaction and/or the nature of or amount of the discount to be applied and/or the identity of the discounted articles.

The portable consumer device may be any suitable device operable to receive, store and transmit a transaction code to a transaction module. The portable consumer device is preferably a Smartphone but may alternatively be a media player, a tablet, a personal digital assistant, a non-Smartphone, a tablet computer, a note book computer, a laptop computer or similar.

The transmission between the portable consumer device and the transaction module may be via a wired link but is preferably via a wireless link. In order to enable transmission, the method may involve the step of establishing a link between the consumer device and the transaction module. For wired links this may involve the step of connecting a suitable cable between the consumer device and the transaction module. For wireless links this may involve the step of establishing a wireless communication link between the consumer device and the transaction module according to the usual protocol of the wireless link. Such a wireless link may take any suitable form including, but not limited to, Bluetooth®, GSM, GPRS, 3G, NFC or the like. Most preferably, the wireless link is achieved via a WiFi network or NFC.

In some wireless link embodiments, the transaction module may transmit the module identity code over the wireless link on a regular or repeating basis. For example, the module identity code may be a WiFi MAC address or Bluetooth® network/device identity code. In such embodiments, the step of transmitting the module identity code may be simultaneous with or in response to the detection of the transaction module by the consumer device. In a preferred solution, the module identity code may be transmitted by the transaction module in response to a request from the consumer device. Preferably, said request is made subsequent to the establishment of a communication link between said consumer device and said transaction module.

The communication means may be operable to vary signal transmission power, as appropriate. This can allow transmissions to be set to an optimum power level bearing in mind the competing requirements of power consumption, range of operation and minimising interference with other transaction modules or other wireless devices. This can also allow different transmission power levels to be implemented for different transaction modules depending on the particular requirements of their individual locations.

The transaction module may be provided with a proximity sensor. The proximity sensor may be operable to detect the close approach of a consumer device or other suitable object to the transaction module and output a proximity alert signal in response thereto. In one preferred embodiment, the proximity sensor is an infrared proximity sensor.

In some embodiments, the transaction module is operable in response to the proximity alert signal. In one such embodiment, the transaction module may be switched from a standby mode to an active mode in response to the proximity alert signal. The transaction module may remain in active mode for a predetermined time interval after the output of the proximity alert signal before reverting to standby mode. In standby mode the communication means and/or other components of the transaction module may be deactivated.

The module identity code may be used as a seed for a dynamically generated module identity. In such embodiments, the authentication algorithm may include the step of deconvolving the dynamic module identity.

The authentication signal may include an indication as to the value of the transaction and/or the nature of or amount of the discount to be applied and/or the identity of the article. This may be by way of a stock keeping unit (SKU) code, a universal product code (UPC) or the like. This information may be provided as an integral part of the token.

The authentication routine may be an algorithm provided to consumer device along with the transaction code. As such, the authentication routine may be separate to or an integral part of the token. If the authentication routine is separate to the token, it may be provided as a downloadable application or on an internet site accessible by the consumer device. In a preferred embodiment, the authentication routine is a local authentication algorithm of the type disclosed in our prior patent no GB2412210. In some embodiments, there may be an algorithm on the consumer device running alongside an algorithm on the transaction server. In such cases, the algorithm at the server may perform a convolution on a particular code number, which is transmitted to the consumer device; and the algorithm on the consumer device may subsequently perform a corresponding deconvolution to reveal the code and enable validity to be assessed.

Following transmission of the authentication signal, the consumer device is preferably operable to transmit a transaction report to a transaction server. The transaction report may be transmitted via any suitable network but is preferably transmitted via a data connection provided by the consumer device such as WiFi, GSM (SMS, USSD), GPRS or 3G. The transaction report allows transactions including, for example, purchase and/or the use of vouchers to be reconciled and audited.

Following a transaction, the transaction module may also be operable to transmit a counterpart transaction report to the transaction server. The counterpart transaction report may be transmitted via any wired or wireless data connection provided to the transaction module, as above.

The transaction server is preferably also operable to provide tokens and/or the authentication to consumer devices. In such instances, tokens may be transmitted automatically or on request. The vouchers may be transmitted via email, SMS, MMS or any other suitable format.

The transaction module may be connected to an EPOS. The connection between the transaction module and the EPOS may be wired or wireless as appropriate. In particular, a wired link may comprise an Ethernet cable, USB cable, RS232, PS/2 or other suitable cable. A wireless link may comprise a WiFi link, a Bluetooth® link, an optical/infrared data link or other wireless data transfer means. In particular, the EPOS may comprise or be connected to a near field communication (NFC) payment unit and the transaction module may be operable to connect to the EPOS via the NFC payment unit.

In such instances where there is a connection between the transaction module and the EPOS, the validity indication may take the form of a signal transmitted to the EPOS. The signal may indicate that the transaction is valid. The signal may additionally indicate the value of the transaction and/or the nature of or amount of the discount to be applied and/or the identity of the article. This may be by way of a stock keeping unit (SKU) code, a universal product code (UPC) or the like. In the event that the transaction is not valid there may a signal indicating that the transaction is invalid or there may be no signal.

In such embodiments, it may still be possible for the transaction module or the EPOS to transmit a confirmatory transaction report to the retailer's own sale record system. Such a confirmatory transaction report may additionally be transmitted to the transaction server via a suitable link. This provides a further opportunity for reconciliation and monitoring of transactions. It may also be possible for the transaction module to transmit a copy of this confirmatory transaction report to the consumer device. The consumer device may store such a confirmatory transaction report in the manner of a receipt.

In alternative embodiments, the transaction module may be provided adjacent to an EPOS and the validity indication may take the form of a visual and/or audible indication to an operator of the EPOS. This allows the method of the present invention to be implemented by retailers independently of their sales record systems. The visual and/or audible indication may additionally indicate the value of the transaction and/or the nature of or amount of the discount to be applied and/or the identity of the discounted article.

Whilst hereinabove, the specification has referred to transactions in connection with the purchase of articles, it would of course be appreciated by the skilled man that the teaching of the present invention may be applied to services and the like. Such services may include personal, social or professional services as appropriate. In particular they may include entertainment services such as watching movies, shows, downloaded digital content or similar and/or playing games, taking holidays or the like.

According to a fourth aspect of the present invention there is provided a method suitable for distributing electronic vouchers to a consumer device, utilising one or more electronic transaction modules within a retail store, the method comprising the steps of: transmitting a module identification code from said transaction module to said consumer device; carrying out on the consumer device an authentication routine using the module identification code; establishing a connection between said consumer device and a transaction server; transmitting an authentication signal indicative of the outcome of the authentication routine, the module identification code and a consumer device identification code from said consumer device to said transaction server; determining on the basis of the transmitted information whether any electronic vouchers are available; and, if any electronic vouchers are available, transmitting an electronic voucher to the consumer device.

The method of the fourth aspect of the present invention may incorporate any or all aspects of the first, second or third aspects of the present invention as desired or as appropriate.

The method of the fourth aspect of the present invention provides a ready means whereby electronic vouchers may be sent to a consumer device whilst they are in a retail store. This real time provision of potentially relevant vouchers increases the likelihood of voucher use (and hence sales of the corresponding product). It also provides an audit on the effectiveness or attractiveness of a marketing campaign.

The electronic voucher may be in the form of an electronic token comprising a transaction code. In addition to the transaction code, the electronic voucher may comprise data for presentation to a user of the consumer device. The data may comprise text and/or images and/or audio as desired or appropriate. In this manner, the user of the consumer device may be made aware of the existence of the voucher and the terms of use. If no electronic vouchers are available, the method may include the further step of transmitting a no voucher message to the consumer device. The no voucher message may comprise text and/or images and/or audio as desired or appropriate.

The method may be implemented automatically whenever a suitable consumer device is in the vicinity of the transaction module. Alternatively, the method may require the user of the consumer device to initiate or approve implementation of the method. Preferably, the or each transaction module is operable to transmit the module identity code over the wireless link on a regular or repeating basis. In this manner, the consumer device may directly proceed to authentication and onward transmission to the transaction server upon detection of the transaction module. Alternatively, the module identity code may be transmitted by the transaction module in response to request from the consumer device. Preferably, said request is made subsequent to the establishment of a communication link between said consumer device and said transaction module.

The transaction module may be provided at an entrance to a retail store. Upon receipt of the module identity code by the consumer device, the method may provide vouchers applicable to all products in the retail store or specific products in the retail store. Additionally or alternatively, the transaction module may be provided at a specific location within a retail store. Upon receipt of the module identity code by the consumer device, the method may provide vouchers applicable to all products in the vicinity of the transaction module location or specific products in the vicinity of the transaction module location. Typically, multiple transaction modules may be provided within a retail store. The modules may be accompanied by suitable information signs indicating their positions and use. In this manner the retailer may run multiple voucher promotions simultaneously.

In addition to or in place of transmitting vouchers to a consumer device, the method may involve the steps of determining the location of the consumer device by looking up the location of the transaction module from the module identification code. This method may involve the step of using connections with one or more modules to determine a user's location between modules. This may be achieved by triangulation or any other suitable method. The location of the consumer device (and hence the user thereof) can thus be tracked over time through different sections of a retail store or through one or more different stores. This can allow information about shopping habits to be obtained thereby helping to optimise pre-emptive voucher distribution, promotional displays and/or retail store layout.

The method may also include the step of determining the location of the transaction module. This determination may be carried out by the module or by the transaction server. The determination may involve the detection of adjacent modules; local WiFi nodes or any other suitable signals, including but not limited to GPS and Bluetooth.

According to a fifth aspect of the present invention, there is provided a system for implementing the method of the fourth aspect of the present invention, the system comprising: one or more transaction modules according to the second aspect of the present invention; and a transaction server.

The fifth aspect of the present invention may incorporate any or all aspects of the first, second, third or fourth aspects of the present invention as desired or as appropriate.

According to a sixth aspect of the present invention there is provided a method of monitoring the activities of one or more consumers using one or more transaction modules according to the second aspect of the present invention, wherein each monitored consumer has an associated consumer device operable to carry out an authentication routine using the module identification code and subsequently transmit an authentication signal indicative of the outcome of the authentication routine, the module identification code and a consumer device identification code to a transaction server, the method comprising the steps of: noting the receipt of authentication signals indicative of the outcome of the authentication routine, the module identification code and a consumer device identification code from said consumer device; looking up the location of the transaction module from the module identification code; and thereby determining the location of the consumer device.

The method of the sixth aspect of the present invention may incorporate any or all aspects of the first, second, third, fourth or fifth aspects of the present invention as desired or as appropriate.

In order to implement the method one or more transaction modules may be positioned within one or more retail stores. The method may involve storing the time and date at which each consumer device location is determined.

The method may be carried out by the transaction server. The method may involve the further steps of plotting consumer locations on a map of transaction module locations of one or more retail stores. The maps may relate to one consumer or multiple consumers. The maps may be adapted to indicate successive locations of the consumer device. In this manner, the map may show the progression of one or more consumers through one or more retail stores. Additionally or alternatively, the map may show the number of consumers passing particular locations within one or more retail stores. This can allow retailers to analyse and monitor the effectiveness of their displays, store layouts or special offers.

According to a seventh aspect of the present invention, there is provided a system for implementing the method of the sixth aspect of the present invention, the system comprising: one or more transaction modules according to the second aspect of the present invention; and a transaction server.

The seventh aspect of the present invention may incorporate any or all aspects of the first, second, third, fourth, fifth or sixth aspects of the present invention as desired or as appropriate.

In order that the present invention is readily understood, one embodiment will now be described further below, by way of example only and with reference to the accompanying drawings, in which:—

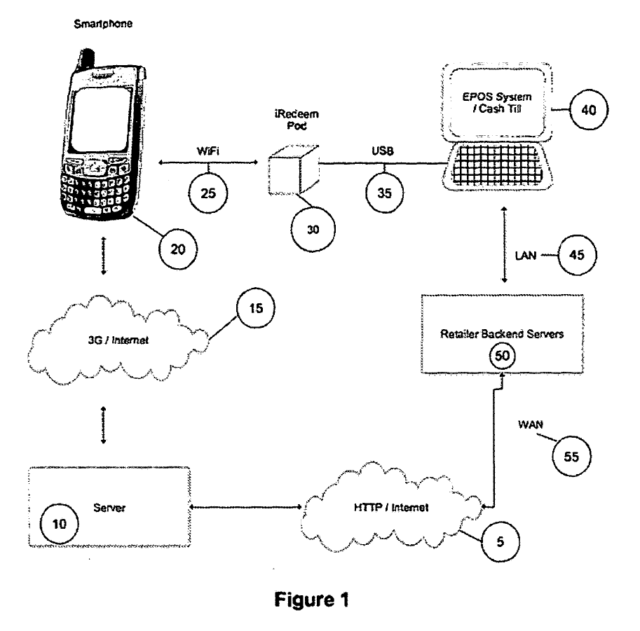

FIG. 1 is a general schematic view of the devices involved in implementing a voucher redemption method according to the present invention;

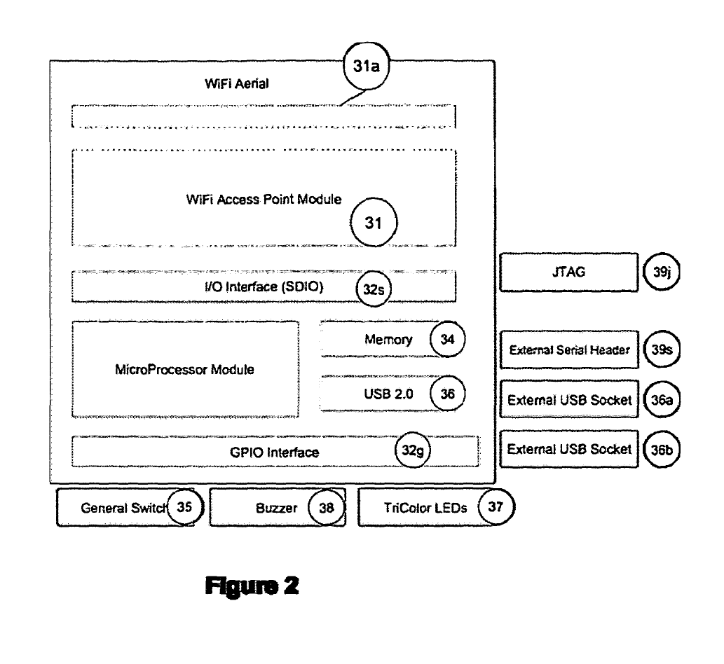

FIG. 2 is schematic illustration of a transaction module according to the present invention;

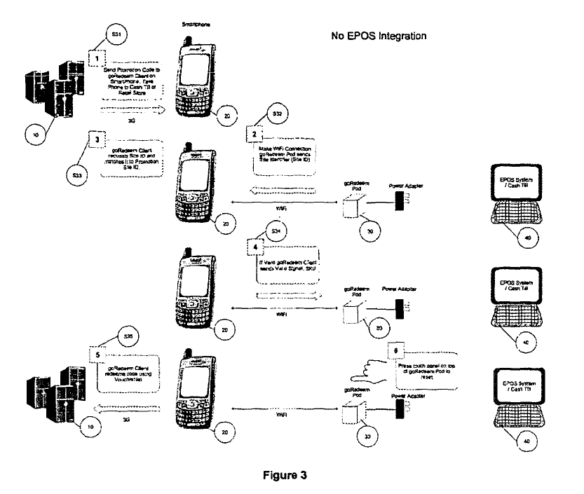

FIG. 3 is schematic illustration of the steps involved in a first implementation of a voucher redemption method according to the present invention;

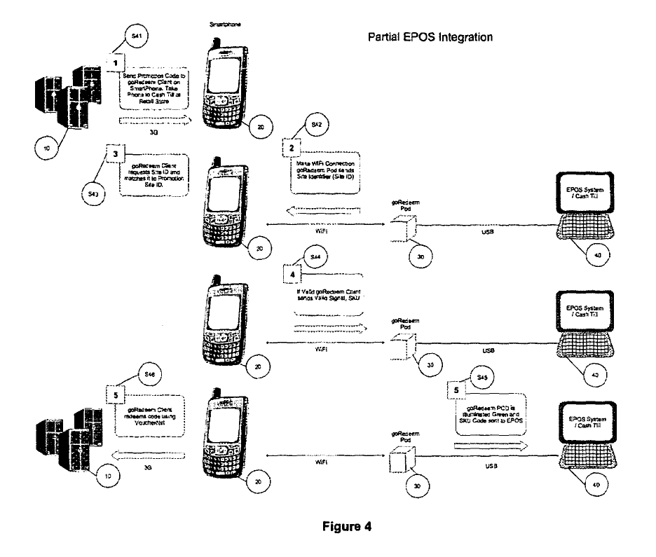

FIG. 4 is schematic illustration of the steps involved in a second implementation of a voucher redemption method according to the present invention;

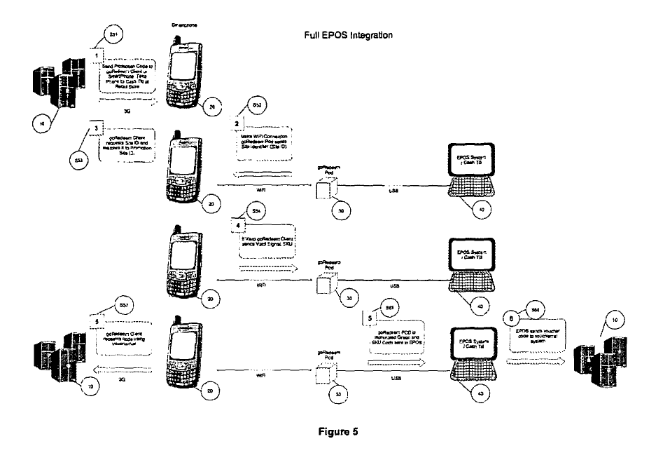

FIG. 5 is schematic illustration of the steps involved in a third implementation of a voucher redemption method according to the present invention;

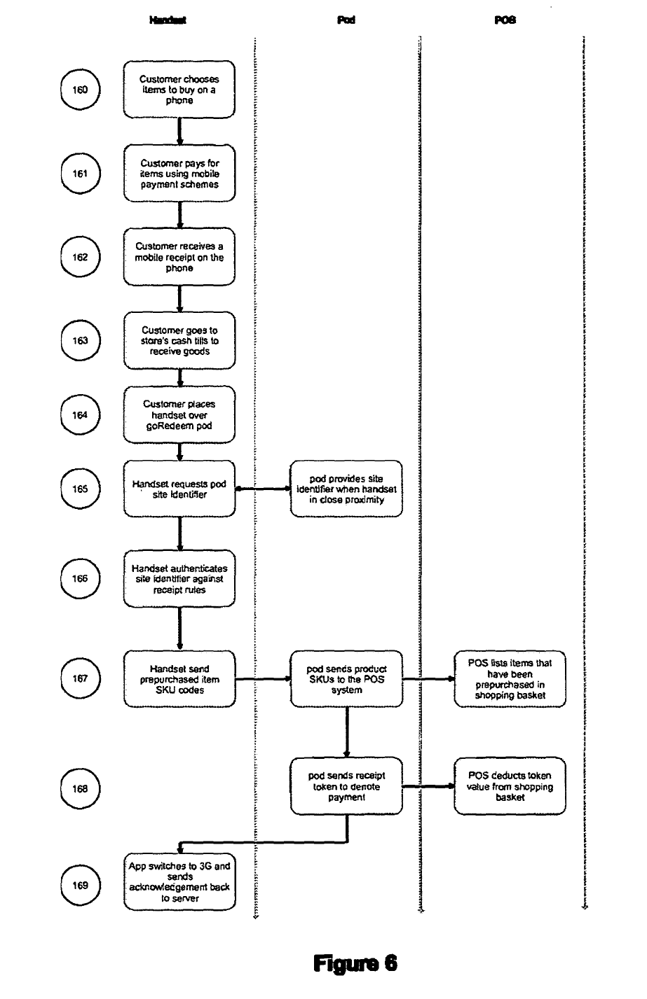

FIG. 6 is schematic illustration of the steps involved in a first implementation of an electronic purchase method according to the present invention;

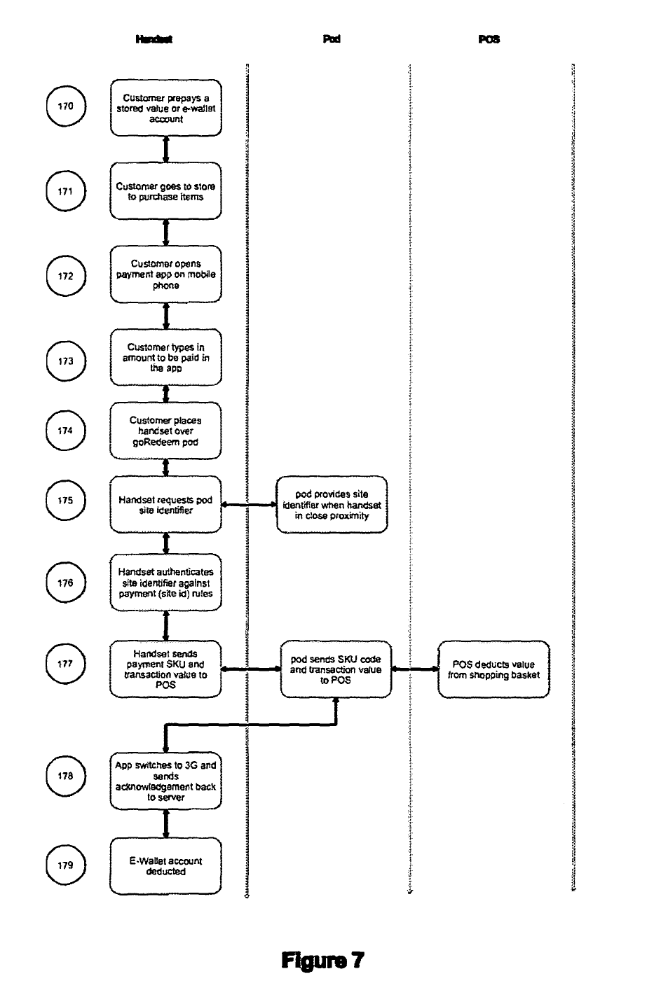

FIG. 7 is schematic illustration of the steps involved in a second implementation of an electronic purchase method according to the present invention;

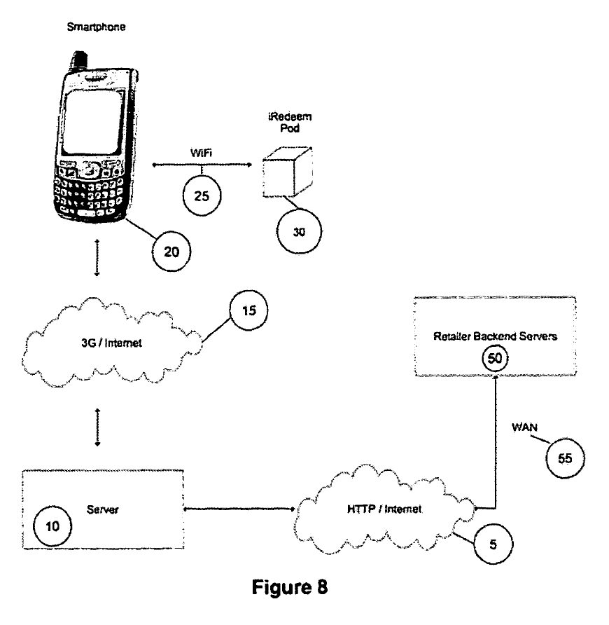

FIG. 8 is a general schematic view of the devices involved in implementing a voucher distribution method according to the present invention;

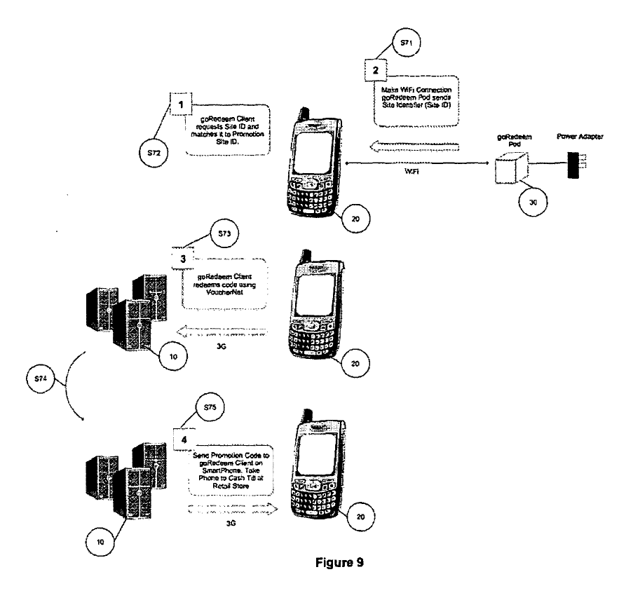

FIG. 9 is schematic illustration of the steps involved in an implementation of a voucher distribution method according to the present invention; and

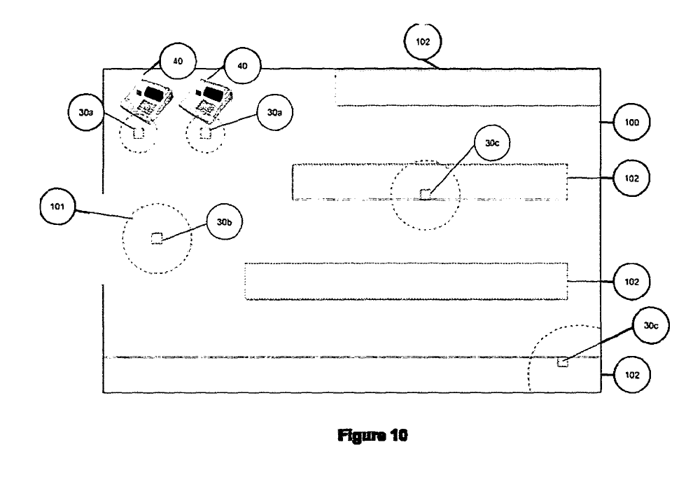

FIG. 10 is a schematic illustration of a retail store provided with one or more transaction modules for the implementation of a voucher redemption and/or a voucher distribution method according to the present invention.

Turning now to FIG. 1, in a voucher redemption method according to the present invention, a transaction server 10 provides an electronic voucher to a Smartphone 20 via an internet connection 15. Whilst the example of FIG. 1 shows a Smartphone 20 linked to the transaction server 10 via an internet connection 15, the skilled man will appreciate that other suitable portable consumer devices can be used in place of Smartphone 20 and other connections may be utilised in place of internet connection 15.

The voucher comprises a unique voucher code. The voucher may also incorporate information as to the identity of the article against which it can be redeemed. In addition either as part of the voucher or alongside the voucher, the transaction server 10 provides an authentication algorithm to Smartphone 20. The algorithm may be a local authentication algorithm of the type outlined in granted patent GB2412210. Typically, the authentication algorithm is implemented in a transaction management application running on the Smartphone 20. In some embodiments, there may be an algorithm on the Smartphone 20 running alongside an algorithm on the transaction server 10. In such cases, the algorithm at the server 10 may perform a convolution on a particular code number which is transmitted to the Smartphone 20; and the algorithm on the Smartphone 20 may subsequently perform a corresponding deconvolution to reveal the code and enable validity to be assessed. The transaction management application may also be operable to manage the receipt or downloading of vouchers and the display of details concerning the vouchers (including value, valid redemption articles, and use restrictions).

To a retailer is provided a transaction module 30 for connection to an EPOS 40. The transaction module 30 is provided with a wired connection 35 to the EPOS 40 and is operable to make a wireless connection with Smartphone 20. In the present example, these connections are a USB connection 35 and a WiFi connection 25 but the skilled man will appreciate that other suitable forms of connection may alternatively be utilised. In one such example, the module may be adapted to connect to the EPOS 40 via a near field communication (NFC) payment unit (not shown) connected to or incorporated into the EPOS 40.

The retailer may obtain a transaction module 30 by registering on a website or otherwise making a request. At this point a unique retailer site identity code may be assigned. The transaction module 30 is then programmed with this unique identity code. Alternatively, the retailer can configure the module 30 with their identity code on receipt by establishing a connection between the module and a suitable device such as a Smartphone or computer. As a further alternative, the retail site may be assigned an identity code corresponding to a pre-programmed code in the module 30.

As is shown more clearly in FIG. 2, the transaction module 30 comprises a WiFi module 31 having an associated aerial 31a. The WiFi module 31 may be operable to vary the transmission power. In this manner, the transmission power can be adapted to provide the required connection range whilst minimising power use or the possibility of interfering with other wireless data connections. The WiFi module 31 is connected to a processor 33 via an input output (I/O) interface 32s. The processor 33 is also provided with a memory means 34 and a USBt connection 36 having two associated USB sockets 36a, 36b. The memory means 34 stores at least the unique identity code. The USB connection 36 facilitates an alternative form of wired connection and/or the downloading of software updates. The skilled man will of course appreciate that an alternative form of connection might be used such as Ethernet, RS232, PS/2 or the like.

Via a further I/O interface 32g, the processor 33 is connected to various input and/or output means. In the present example, the output means comprise a visual output means in the form of a tricolour LED 37, audible output means in the form of buzzer 38, electronic signal input means in the form of switch 35 and electronic signal input/output means in the form of external serial header 39s and JTAG 39j.

In addition to the components shown, it is possible for additional components to be provided. These additional components may include a proximity sensor (not shown). The proximity sensor may be operable to detect the close approach of a device. In response to this detection, the module 30 may be switched from a standby mode to an active mode. The module 30 may then revert back to the standby mode after a specific time interval.

A further alternative is for the module 30 to be provided with an NFC module (not shown). This could be operable to connect to a standard NFC payment unit incorporated into or connected to the EPOS 40.

Reverting to FIG. 1, the EPOS 40 is connected to a retailer sale record system 50 via LAN 45. The retailer systems 50 may be connected via WAN 55 and an associated internet connection 5 to the transaction server 10.

In use, a consumer who has received a voucher on their Smartphone 20 brings their Smartphone 20 to a retail location equipped with a transaction module 30. When purchasing an article, a connection is established between the Smartphone 20 and the transaction module 30. Once the connection is established, the transaction module transmits its identity code to the Smartphone 20. The Smartphone 20 subsequently runs the voucher code and identity code through the authentication algorithm. If the codes are authenticated, the Smartphone 20 sends an authentication signal to transaction module 30 and a voucher use report to transaction server 10. Upon receipt of the authentication signal, the transaction module 30 can output a corresponding validity indication in response. The validity indication can be output via any or all of the output means 36, 37, 38, 39 allowing the retailer to apply the relevant discount via their EPOS 40.

The above method therefore enables any retailer possessing a transaction module 30 to process and apply an electronic voucher provided on a Smartphone 20.

Since the Smartphone 20 transmits the voucher use report to the transaction server 10 it is not necessary to implement the voucher scheme directly with the retailers system 50. This therefore provides a simpler and potentially cheaper way of implementing a voucher scheme at a wide variety of unrelated retail outlets, whilst still providing a reconcilable voucher use audit trail. Of course, the system may optionally be integrated with retailer systems 50 if desired enabling retailers to conduct their own reconciliation and enabling a further confirmatory voucher use report to be transmitted from the retailer system 50 to the transaction server 10.

A further option is for the transaction module identity code to be a WiFi network identity (such as WiFi SSID and/or MAC address) transmitted repeatedly/regularly by the transaction module 30. In this way, the Smartphone 20 receives the identity code directly upon detection of the transaction module 30.

Turning now to FIG. 3 a first possible implementation of the present invention is described. In this implementation, the transaction module 30 is not integrated with the retailer's EPOS 40. This implementation is particularly suited to small independent retailers who may not have a large back office system.

At step 31 the consumer is sent a promotional voucher by the transaction server 20. The promotional voucher is associated with a unique voucher number. The voucher may also be associated with a retailer SKU (stock keeping unit) code. Furthermore, if the promotion is limited by retailer or area, the voucher may also include a site ID code, and optionally group ID code. The consumer, now being aware of the voucher promotion, travels to a participating retail store with their Smartphone 20 to redeem the offer. At step 32, the consumer opens the transaction management application on the Smartphone 20 and selects the redeem option associated with the voucher causing the Smartphone 20 to establish a WiFi connection with the retailer's transaction module 30. At step 33 the transaction module 30 sends a ID code stored in the memory 34 to the Smartphone 20. Once received, the transaction management application uses the authentication algorithm to authenticate the Site ID code.

In some embodiments, the ID code may be generated dynamically from a seed stored in the memory 34. If so, the transaction management application may be operable to deconvolve the dynamic ID, if necessary for authentication.

If the ID code is VALID, this is communicated by the Smartphone 20 to the transaction module 30 over WiFi at step 34. The transaction module 30 then activates the tricolour LED 37 to illuminate green to indicate validity. Optionally, the buzzer 38 will emit a valid beep. If the ID code is INVALID, this is also communicated to the transaction module 30 over WiFi. The transaction module 30 activates the tricolour LED 37 to illuminate red to indicate invalidity. Optionally, the buzzer 38 will emit an invalid beep.

Based on the valid/invalid indication, the retailer can then choose whether or not to apply the discount. So that the retailer does not miss the indication, the tricolour LED 37 will remain illuminated until the retailer touches the top of the transaction module 30 (or switch 35) to ‘reset’ at step 36. Whilst awaiting the valid/invalid indication, the tricolour LED 37 may illuminate amber to indicate authentication pending.

After authentication, the transaction management application causes Smartphone 20 to break the WiFi connection or, alternatively, the WiFi connection is maintained until the Smartphone 20 moves out of connection range. At step 35 the transaction management application then causes Smartphone 20 to transmit a voucher use report to transaction server 10. The transaction server 10 can thus monitor and audit the use of voucher.

Turning now to FIG. 4 a second possible implementation of the present invention is described. In this implementation, the transaction module 30 is integrated with the retailer's EPOS 40. The EPOS 40 is not however integrated with a sales record system 50 or is not integrated with the sales record system 50 for the purpose of voucher redemption. This implementation is suited to small independent retailers who may not have a large back office system and/or to small or large retailers who do not wish to integrate the voucher redemption scheme with their own sales systems 50.

At step 41 the consumer is sent a promotional voucher by the transaction server 20. The promotional voucher is associated with a unique voucher number. The voucher may also be associated with a retailer SKU (stock keeping unit) code. Furthermore, if the promotion is limited by retailer or area, the voucher may also include a site ID code, and optionally group ID code. The consumer, now being aware of the voucher promotion, travels to a participating retail store with their Smartphone 20 to redeem the offer. At step 42, the consumer opens the transaction management application on the Smartphone 20 and selects the redeem option associated with the voucher causing the Smartphone 20 to establish a WiFi connection with the retailer's transaction module 30. At step 43 the transaction module 30 sends an ID code stored in the memory 34 to the Smartphone 20. Once received, the transaction management application uses the authentication algorithm to authenticate the ID code.

In some embodiments, the ID code may be generated dynamically from a seed stored in the memory 34. If so, the transaction management application may be operable to deconvolve the dynamic ID, if necessary for authentication.

If the ID code is VALID, this is communicated by the Smartphone 20 to the transaction module 30 over WiFi at step 44. This communication may include an SKU code associated with the article (or with the article at a discounted price). The transaction module 30 then activates the tricolour LED 37 to illuminate green to indicate validity. Optionally, the buzzer 38 will emit a valid beep. If the Site ID code is INVALID, this is also communicated to the transaction module 30 over WiFi. The transaction module 30 activates the tricolour LED 37 to illuminate red to indicate invalidity. Optionally, the buzzer 38 will emit an invalid beep.

In addition to the visible (and audible) indications, at step 45, the USB connection 35 is used to transmit to the EPOS 40 a signal indicating that the voucher is valid. This signal may be an SKU code associated with the article (or with the article at a discounted price). The SKU code may typically be transmitted in the form of keyboard keystrokes (although other variations of interface could be accommodated). This enables the EPOS 40 to process the SKU code as though it were entered directly by an operator. The EPOS 40 can then account for the redemption of the voucher according to its normal operation.

Based on the valid/invalid indication, the retailer can then choose whether or not to apply the discount. So that the retailer does not miss the indication, the tricolour LED 37 will remain illuminated until the retailer touches the top of the transaction module 30 (or switch 35) to ‘reset’. Whilst awaiting the valid/invalid indication, the tricolour LED 37 may illuminate amber to indicate authentication pending.

After authentication, the transaction management application causes Smartphone 20 to break the WiFi connection. At step 46 the transaction management application then causes Smartphone 20 to transmit a voucher use report to transaction server 10. The transaction server 10 can thus monitor and audit the use of vouchers.

Turning now to FIG. 5 a third possible implementation of the present invention is described. In this implementation, the transaction module 30 is integrated with the retailer's EPOS 40, which is in turn integrated with a sales record system 50. This implementation is suited to large or small retailers who wish to integrate the voucher redemption scheme with their own sales record systems 50.

At step 51 the consumer is sent a promotional voucher by the transaction server 20. The promotional voucher is associated with a unique voucher number. The voucher may also be associated with a retailer SKU (stock keeping unit) code. Furthermore, if the promotion is limited by retailer or area, the voucher may also include a site ID code, and optionally group ID code. The consumer, now being aware of the voucher promotion, travels to a participating retail store with their Smartphone 20 to redeem the offer. At step 52, the consumer opens the transaction management application on the Smartphone 20 and selects the redeem option associated with the voucher causing the Smartphone 20 to establish a WiFi connection with the retailer's transaction module 30. At step 53 the transaction module 30 sends an ID code stored in the memory 34 to the Smartphone 20. Once received, the transaction management application uses the authentication algorithm to authenticate the ID code.

In some embodiments, the ID code may be generated dynamically from a seed stored in the memory 34. If so, the transaction management application may be operable to deconvolve the dynamic ID, if necessary for authentication.

If the ID code is VALID, this is communicated by the Smartphone 20 to the transaction module 30 over WiFi at step 54. This communication may include an SKU code associated with the article (or with the article at a discounted price). The transaction module 30 then activates the tricolour LED 37 to illuminate green to indicate validity. Optionally, the buzzer 38 will emit a valid beep. If the ID code is INVALID, this is also communicated to the transaction module 30 over WiFi. The transaction module 30 activates the tricolour LED 37 to illuminate red to indicate invalidity. Optionally, the buzzer 38 will emit an invalid beep.

In addition to the visible (and audible) indications, at step 55, the USB connection 35 is used to transmit to the EPOS 40 a signal indicating that the voucher is valid. This signal may be an SKU code associated with the article (or with the article at a discounted price). The SKU code may typically be transmitted in the form of keyboard keystrokes (although other variations of interface could be accommodated). This enables the EPOS 40 to process the SKU code as though it were entered directly buy an operator. The EPOS 40 can then account for the redemption of the voucher according to its normal operation. Subsequently, the EPOS 40 can also transmit a confirmatory voucher use report to the retailer sales record system 50 and or the transaction server 10 at step 56.

Based on the valid/invalid indication, the retailer can then choose whether or not to apply the discount. So that the retailer does not miss the indication, the tricolour LED 37 will remain illuminated until the retailer touches the top of the transaction module 30 (or switch 35) to ‘reset’. Whilst awaiting the valid/invalid indication, the tricolour LED 37 may illuminate amber to indicate authentication pending.

After authentication, the transaction management application causes Smartphone 20 to break the WiFi connection. At step 57 the transaction management application then causes Smartphone 20 to transmit a voucher use report to transaction server 10. The transaction server 10 can thus monitor and audit the use of vouchers. Furthermore, receiving direct reports of voucher use from both the consumer and the retailer can aid reconciliation.

In addition to the specific example above, the method and system of the present invention may be applied to other electronic transactions. In particular, such transactions may include electronic purchases or payments.

Turning now to FIG. 6, this provides a schematic illustration of the use of a transaction module 30 to make or verify electronic purchases or payments. At the initial step 160, the consumer selects the articles for purchase using the Smartphone 20. The consumer then arranges for payment at step 161 using any suitable payment service. The payment service then generates a corresponding receipt, including a transaction code, the receipt being transmitted to the Smartphone 20. The receipt can then be stored by a transaction management application on the Smartphone 20. At step 163 the consumer can then approach the EPOS 40 (and associated transaction module 30), carrying the articles for purchase, if appropriate.

After approaching the EPOS 40 and transaction module 30, the consumer may open the transaction management application on Smartphone 20 and select the appropriate receipt. At step 164 a WiFi connection is established between the transaction module 30 and the Smartphone 20. At step 165, the transaction module 30 sends an ID code stored in the memory 34 to the Smartphone 20. Once received, at step 166, the transaction management application uses the authentication algorithm to authenticate the Site ID code.

In some embodiments, the ID code may be generated dynamically from a seed stored in the memory 34. If so, the transaction management application may be operable to deconvolve the dynamic ID, if necessary for authentication.

If the ID code is VALID, this is communicated by the Smartphone 20 to the transaction module 30 over WiFi at step 167. This communication includes the SKU code(s) associated with the article(s) selected for purchase and the monetary value associated with the receipt. The USB connection 35 is used to transmit to the EPOS 40 a signal indicating whether the transaction is valid, the signal including the SKU code(s) associated with the article(s) selected for purchase and the monetary value associated with the receipt. This enables the EPOS 40 to process the SKU code(s) as though entered directly by an operator and thereby list the article(s) for purchase. Alongside this, the EPOS 40 can determine the receipt value at step 168 and compare this with the purchase price of the article(s) for purchase. The EPOS 40 can then account for transaction according to its normal operation. Subsequently, the EPOS 40 can also transmit a confirmatory transaction report to the retailer sales record system 50 and or the transaction server 10.

After authentication, the transaction management application causes Smartphone 20 to break the WiFi connection. At step 169 the transaction management application then causes Smartphone 20 to transmit a transaction report to transaction server 10. The transaction server 10 can thus monitor and audit transactions. Furthermore, receiving direct reports of the transaction from both the consumer and the retailer can aid reconciliation.

Turning now to FIG. 7, this provides a schematic illustration of an alternative use of a transaction module 30 to make or verify electronic purchases or payments.

At the initial step 170, the consumer makes a prepayment into an e-wallet. The e-wallet may be operated by or may be linked to a transaction management application on the Smartphone 20. At step 171 the consumer can approach the EPOS 40 (and associated transaction module 30), carrying the articles for purchase, if appropriate.

After approaching the EPOS 40 and transaction module 30, the consumer opens the transaction management application on Smartphone 20 at step 172. The consumer then enters a purchase value into the transaction management application and a corresponding transaction code is generated by the transaction management application. At step 174, a WiFi connection is established between the transaction module 30 and the Smartphone 20. At step 175, the transaction module 30 sends an ID code stored in the memory 34 to the Smartphone 20. Once received, at step 176, the transaction management application uses the authentication algorithm to authenticate the ID code.

In some embodiments, the ID code may be generated dynamically from a seed stored in the memory 34. If so, the transaction management application may be operable to deconvolve the dynamic ID, if necessary for authentication.

If the ID code is VALID, this is communicated by the Smartphone 20 to the transaction module 30 over WiFi at step 177. This communication includes the SKU code(s) associated with the article(s) selected for purchase and the monetary value associated with the transaction. The USB connection 35 is used to transmit to the EPOS 40 a signal indicating that the transaction is valid, the signal including the SKU code(s) associated with the article(s) selected for purchase and the monetary value associated with the receipt. This enables the EPOS 40 to process the SKU code(s) as though entered directly by an operator and thereby list the article(s) for purchase. Alongside this, the EPOS 40 can determine the receipt value at step 168 and compare this with the purchase price of the article(s) for purchase. The EPOS 40 can then account for transaction according to its normal operation. Subsequently, the EPOS 40 can also transmit a confirmatory transaction report to the retailer sales record system 50 and or the transaction server 10.

After authentication, the transaction management application causes Smartphone 20 to break the WiFi connection. At step 178 the transaction management application then causes Smartphone 20 to transmit a transaction report to transaction server 10. The transaction server 10 can thus monitor and audit transactions. Furthermore, receiving direct reports of the transaction from both the consumer and the retailer can aid reconciliation. A final step 179 is the subsequent deduction of value from the e-wallet. This may be carried out by the transaction management module of the Smartphone 20 or by the transaction server.

The transaction module 30 of the present invention may also be utilised in the distribution of electronic vouchers. In such a scheme, the transaction module 30 need not be connected to an EPOS 40, as is shown in FIG. 8 which illustrates the minimum systems involved in voucher distribution using module 30. Instead, the transaction module 30 may be provided at any convenient location within a retail store.

Turning now to FIG. 9, the Smartphone 20 establishes a wireless connection 25 with transaction module 30. In some embodiments this may take place automatically whenever a module 30 is in range of the Smartphone 20. In other embodiments, this will only take place if the customer has enabled the transaction management application on their Smartphone 20. In the course of this connection, at step 71, the transaction module 30 sends the Smartphone 20 a site ID code stored in memory 34. Once received, the transaction management application, at step 72, uses the authentication algorithm to authenticate the site ID code.

If the Site ID code is VALID, this is communicated, at step 73, by the Smartphone 20 to the transaction server 10 via the Smartphone's own data connection 15. Along with the authentication result, the Smartphone 20 communicates the site ID code and a unique ID code associated with the consumer or Smartphone 20. As previously mentioned in one optional embodiment, the ID code may be a WiFi network identity transmitted repeatedly or regularly by the transaction module 30. In this manner detection of the transaction module 30 WiFi signals can lead directly to authentication by the Smartphone 20. Alternatively, after a connection is established between the Smartphone 20 and the transaction module 30, the Smartphone 20 may request that the transaction module 30 transmits the ID code.

At step 74, the transaction server 10 determines, on the basis of the transmitted information, whether any electronic vouchers are available. This may involve performing a simple look up of live voucher offers stored on the transaction server 10. Alternatively, this may involve dynamically connecting to the retailer's systems 50 and querying the eligibility of the consumer for vouchers. If it transpires that any electronic vouchers are available, at step 75 the transaction server 10 transmits the voucher to the Smartphone 20. At this stage, the transaction server 10 may also transmit a corresponding notification to the retailer systems 50.

Turning now to FIG. 10, a simplified schematic representation of the provision of transaction modules 30 within a retail store 100 for the purpose of both voucher distribution and voucher redemption is shown. Turning first to redemption, within the store are provided two EPOS terminals 40. Connected to each EPOS 40 is a transaction module 30a operable for the redemption of electronic vouchers as described above. Each module 30a is set up such that the connection range of transmitted signals is substantially illustrated by the dotted line and thus they do not overlap. In this manner, the systems can be used independently by consumers at each EPOS 40.

Turning now to distribution, one module 30b is provided at the entrance 101 of the store 100. This module 30b is adapted such that its connection range covers the whole entrance 101. In this way, all consumers entering the store 100 with an enabled Smartphone 20 may connect to module 30b. As a result of this connection, it can be determined that the consumer is in or about to enter the store 100. Consequently, the consumer may be provided with an electronic voucher applicable to one or more products within the store. The consumer can then choose to purchase the products and apply the voucher using modules 30a.

In addition to or in place of modules 30b, one or more modules 30c may be provided on display shelves 102. These modules 30c may be provided adjacent to specific products and in particular adjacent to a promotional offer or display illustrating said promotional offer. The modules 30c are adapted to have a short connection range. In this way, all consumers entering the store passing close to modules 30c, for instance if considering purchasing the specific products adjacent to the module 30c, may connect to module 30c. As a result of this connection, it can be determined that the consumer is in the vicinity of the specific products. Consequently, the consumer may be provided with information and/or an electronic voucher applicable to these specific products. The information may include advertisements relating to the qualities of the products or particular offers on purchase of the products. The consumer can then choose to purchase the products. If an electronic voucher is provided, the consumer can apply the voucher using modules 30a at the time of purchase.

The transaction server 10 may also be operable to determine the location of Smartphone 20 on each occasion that an authentication signal is received. This can allow the transaction server 10 to store information relating to the movements of the Smartphone 20 (and hence its user) within and between stores. This information can be monitored to enable stores to analyse the effectiveness of layouts, offers or displays. Typically, this information may involve plotting the location of successive authentication events from a single Smartphone or the number of authentication events at one or more locations.

It is of course to be understood that the invention is not to be restricted to the details of the above embodiment which is described by way of example only.

1-57. (canceled)

58. A method suitable for making electronic transactions using an electronic token stored on a portable consumer device, the method comprising the steps of: transmitting a module identification code from a transaction module to said consumer device; carrying out on the consumer device an authentication routine using the identification code and a transaction code contained in the electronic token; transmitting an authentication signal indicative of the outcome of the authentication routine from said consumer device to said transaction module; and outputting a suitable validity indication from said transaction module in response thereto.

59. A method as claimed in claim 58, wherein the transaction is a purchase and the token is an electronic receipt or wherein the transaction is voucher redemption and the token is an electronic voucher.

60. A method as claimed in claim 58, wherein the module identity code is used as a seed for a dynamically generated module identity and the authentication algorithm includes the step of deconvolving the dynamic module identity.

61. A method as claimed in claim 58, wherein the authentication routine is an algorithm provided to consumer device along with the transaction code.

62. A method as claimed in claim 58, wherein the authentication routine includes an algorithm on the consumer device running alongside an algorithm on a transaction server.

63. A method as claimed in claim 58, wherein following transmission of the authentication signal, the consumer device is operable to transmit a transaction report to a transaction server.

64. A method as claimed in claim 58, wherein the transaction server is also operable to provide tokens and/or authentication to consumer devices.

65. A method as claimed in claim 58, wherein the validity indication takes the form of a signal transmitted to an EPOS indicating that the transaction is valid or the validity indication takes the form of a visual and/or audible indication to an operator of the EPOS.

66. An electronic transaction module suitable for making electronic transactions using an electronic token stored on a portable consumer device, the transaction module comprising: memory means for storing a module identity code; communication means for transmitting said module identity code to a portable consumer device, and receiving an authentication signal therefrom; and output means for outputting a suitable validity indication in response to said authentication signal.

67. An electronic transaction module as claimed in claim 66, wherein the step of transmitting the module identity code is: simultaneous with or in response to the detection of the transaction module by the consumer device; or in response to a request from the consumer device.

68. An electronic transaction module as claimed in claim 67, wherein the transaction module is provided with a proximity sensor operable to detect the close approach of a consumer device and output a proximity alert signal in response thereto.

69. An electronic transaction module as claimed in claim 66, wherein the validity indication takes the form of a signal transmitted to an EPOS indicating that the transaction is valid or the validity indication takes the form of a visual and/or audible indication to an operator of the EPOS.

70. A method suitable for distributing electronic vouchers to a consumer device, within a retail store utilising one or more electronic transaction modules comprising: memory means for storing a module identity code; communication means for transmitting said module identity code to a portable consumer device, and receiving an authentication signal therefrom; and output means for outputting a suitable validity indication in response to said authentication signal, the method comprising the steps of: transmitting a module identification code from said transaction module to said consumer device; carrying out on the consumer device an authentication routine using the module identification code; establishing a connection between said consumer device and a transaction server; transmitting an authentication signal indicative of the outcome of the authentication routine, the module identification code and a consumer device identification code from said consumer device to said transaction server; determining on the basis of the transmitted information whether any electronic vouchers are available; and, if any electronic vouchers are available, transmitting an electronic voucher to the consumer device.

71. A method as claimed in claim 70, wherein the electronic voucher is in the form of an electronic token comprising a transaction code.

72. A method as claimed in claim 70, wherein if no electronic vouchers are available, the method includes the further step of transmitting a no voucher message to the consumer device.

73. A method as claimed in claim 70, wherein each transaction module is operable to transmit the module identity code over the wireless link: on a regular or repeating basis; or in response to a request from the consumer device.

74. A method as claimed in claim 70, wherein the transaction module is provided at an entrance to a retail store or at a specific location within a retail store and upon receipt of the module identity code by the consumer device, the method provides vouchers applicable to all products in the retail store or vouchers applicable to specific products in the retail store in the vicinity of the transaction module location.

75. A method of monitoring the activities of one or more consumers using one or more transaction modules comprising: memory means for storing a module identity code; communication means for transmitting said module identity code to a portable consumer device, and receiving an authentication signal therefrom; and output means for outputting a suitable validity indication in response to said authentication signal, wherein each monitored consumer has an associated consumer device operable to carry out an authentication routine using the module identification code and subsequently transmit an authentication signal indicative of the outcome of the authentication routine, the module identification code and a consumer device identification code to a transaction server, the method comprising the steps of: noting the receipt of authentication signals indicative of the outcome of the authentication routine, the module identification code and a consumer device identification code from said consumer device; looking up the location of the transaction module from the module identification code; and thereby determining the location of the consumer device.

76. A method as claimed in claim 75, wherein the method involves storing the time and date at which each consumer device location is determined.

77. A system comprising: one or more electronic transaction modules comprising: memory means for storing a module identity code; communication means for transmitting said module identity code to a portable consumer device, and receiving an authentication signal therefrom; and output means for outputting a suitable validity indication in response to said authentication signal; and a transaction server, the system being operable to: make electronic transactions using an electronic token stored on a portable consumer device in accordance with the method of claim 58.

78. A system comprising: one or more electronic transaction modules comprising: memory means for storing a module identity code; communication means for transmitting said module identity code to a portable consumer device, and receiving an authentication signal therefrom; and output means for outputting a suitable validity indication in response to said authentication signal; and a transaction server, the system being operable to: distribute electronic vouchers to a consumer device in accordance with the method of claim 75.

79. A system comprising: one or more electronic transaction modules comprising: memory means for storing a module identity code; communication means for transmitting said module identity code to a portable consumer device, and receiving an authentication signal therefrom; and output means for outputting a suitable validity indication in response to said authentication signal; and a transaction server, the system being operable to: monitor the activities of one or more consumers in accordance with the method of claim 75.

80. A system as claimed in claim 77, wherein the transaction server is operable to: provide tokens; reconcile tokens; and/or provide authentication to consumer devices.

81. A system as claimed in claim 77, wherein the authentication routine includes an algorithm on the consumer device running alongside an algorithm on the transaction server.

82. A system as claimed in claim 77, wherein the validity indication takes the form of a signal transmitted to an EPOS indicating that the transaction is valid or the validity indication takes the form of a visual and/or audible indication to an operator of the EPOS.
